(19) United States
(12) Patent Application Publication
(10) Pub. No.: US 2016/0308887 A1
(43) Pub. Date: Oct. 20, 2016

(54) IN-VEHICLE NETWORK INTRUSION DETECTION SYSTEM AND METHOD FOR CONTROLLING THE SAME

(71) Applicants: Hyundai Motor Company, Seoul (KR); Kia Motors Corporation, Seoul (KR); Industry-Academic Cooperation Foundation, Chosun University, Gwangju (KR); SNU R&DB Foundation, Seoul (KR)

(72) Inventors: Ho Jin Jung, Seoul (KR); Chung Hi Lee, Seoul (KR); Ho Yoo, Suwon (KR); Byoung Wook Lee, Seoul (KR); Hyun Soo Ahn, Seoul (KR); Ho Youn Kim, Seoul (KR); Young Sik Moon, Seoul (KR); Jun Young Woo, Seoul (KR); Young Sik Kim, Gwangju (KR); Kang Seok Lee, Goyang (KR); Jong Seon No, Seoul (KR)

(21) Appl. No.: 14/959,740

(22) Filed: Dec. 4, 2015

(30) Foreign Application Priority Data
Apr. 17, 2015 (KR) 10-2015-0054404

(51) Int. Cl. H04L 29/06; H04L 29/08

(52) U.S. Cl. CPC H04L 63/1416; H04L 63/1425; H04L 67/12

(57) ABSTRACT

A method for detecting intrusion into an in-vehicle network using an intrusion detection system (IDS) of a vehicle includes: receiving messages of the in-vehicle network in a preset cycle, calculating a current count value per message of the received messages, receiving operation state information of the vehicle when the cycle starts, determining a normal count value per message corresponding to the operation state information, calculating a linearly approximated relative distance function per message using the current count value and the normal count value, and determining whether an intrusion state occurs by comparing the calculated linearly approximated relative distance function per message to a preset threshold value.

### CROSS-REFERENCE TO RELATED APPLICATION

This application claims the benefit of and priority to Korean Patent Application No. 10-2015-0054404, filed on Apr. 17, 2015, which is hereby incorporated by reference as if fully set forth herein.

### BACKGROUND OF THE DISCLOSURE

1. Field of the Disclosure

The present disclosure relates to an intrusion detection system (IDS) for preventing intrusion into an in-vehicle network and a method for controlling the same.

2. Discussion of the Related Art

Recently, functions of electronic control units (ECUs) installed in a vehicle have been greatly increased. Meanwhile, network access from a vehicle is enabled through a wireless network. However, if the vehicle is connected to a wireless communication network and a peripheral network environment as described above, intrusion into the ECUs of the vehicle can be achieved remotely through the network. Malfunction of the vehicle due to an external intrusion may be fatal to a driver or passenger of the vehicle.

Problematically, currently produced vehicles have no or little solution to the above problem. Although a variety of IDS technologies have been proposed, the technologies cannot be easily implemented in an in-vehicle system due to complex algorithms and large calculation amounts. Thus, such technologies are typically not employed in vehicles.

As such, more accurate and efficient detection of an intrusion through an in-vehicle network is needed. In particular, an IDS appropriate for a controller area network (CAN) to be used in a vehicle is necessary.

### SUMMARY OF THE DISCLOSURE

Accordingly, the present disclosure is directed to an in-vehicle network intrusion detection system (IDS) and a method for controlling the same which substantially obviate one or more problems due to limitations and disadvantages of the related art. An object of the present disclosure is to provide an intrusion detection system (IDS) for detecting and preventing intrusion into an in-vehicle network, which disturbs safe driving, and a method for controlling the same.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

According to embodiments of the disclosure, a method for detecting intrusion into an in-vehicle network using an intrusion detection system (IDS) of a vehicle includes: receiving messages of the in-vehicle network in a preset cycle; calculating a current count value per message of the received messages; receiving operation state information of the vehicle when the cycle starts; determining a normal count value per message corresponding to the operation state information; calculating a linearly approximated relative distance function per message using the current count value and the normal count value; and determining whether an intrusion state occurs by comparing the calculated linearly approximated relative distance function per message to a preset threshold value.

Furthermore, according to embodiments of the present disclosure, an intrusion detection system (IDS) of a vehicle includes: a first module receiving messages of an in-vehicle network in a preset cycle and calculating a current count value per message of the received messages; a second module receiving operation state information of the vehicle when the cycle starts and determining a normal count value per message corresponding to the operation state information; and a third module calculating a linearly approximated relative distance function per message using the current count value and the normal count value and determining whether an intrusion state occurs by comparing the calculated linearly approximated relative distance function per message to a preset threshold value.

Furthermore, according to embodiments of the present disclosure, a non-transitory computer readable medium containing program instructions for detecting intrusion into an in-vehicle using an intrusion detection system (IDS) of a vehicle includes: program instructions that receive messages of the in-vehicle network in a preset cycle; program instructions that calculate a current count value per message of the received messages; program instructions that receive operation state information of the vehicle when the cycle starts; program instructions that determine a normal count value per message corresponding to the operation state information; program instructions that calculate a linearly approximated relative distance function per message using the current count value and the normal count value; and program instructions that determine whether an intrusion state occurs by comparing the calculated linearly approximated relative distance function per message to a preset threshold value.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 shows exemplary installation locations of an intrusion detection system (IDS) in a vehicle according to embodiments of the present disclosure;

FIG. 2 is a block diagram showing an exemplary structure of the IDS according to embodiments of the present disclosure; and

FIG. 3 is a flowchart of an intrusion detection algorithm performed by the IDS according to embodiments of the present disclosure.

### DETAILED DESCRIPTION OF THE DISCLOSURE

Reference will now be made in detail to the embodiments of the present disclosure, examples of which are illustrated in the accompanying drawings. Like reference numerals in the drawings denote like elements and repeated descriptions thereof will be omitted. The suffixes “module”, “---er/or” and “unit” of elements herein are used for convenience of description and thus can be used interchangeably and do not have any distinguishable meanings or functions.

In the following description of the present disclosure, a detailed description of known functions and configurations incorporated herein will be omitted when it may make the subject matter of the present disclosure unclear. It should be understood that there is no intent to limit embodiments of the disclosure to the particular forms disclosed, rather, embodiments of the disclosure are to cover all modifications, equivalents, and alternatives falling within the spirit and scope of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Referring now to the disclosed embodiments, according to techniques described herein, intrusion can be detected by processing an actual identifier (ID) count per message ID and a reference ID count per operation state through a predetermined intrusion detection algorithm using two types of input values (e.g., operation state information of a vehicle and controller area network (CAN) messages) which are intrusion detection targets of an in-vehicle CAN network, and determining whether the actual ID count per message ID is normal, in an intrusion detection system (IDS). If an intrusion is detected, the IDS transmits a warning message as output.

The intrusion detection algorithm may be an approximated relative distance function which is an entropy based function. Here, the intrusion detection algorithm may be obtained by linearly approximating a log part of an actual relative distance function. Whether the message is abnormal may be determined by comparing a calculated value of the approximated function to a preset threshold value.

Before specifically describing the algorithm, a description is given below of the installation location and structure of an IDS according to the present disclosure.

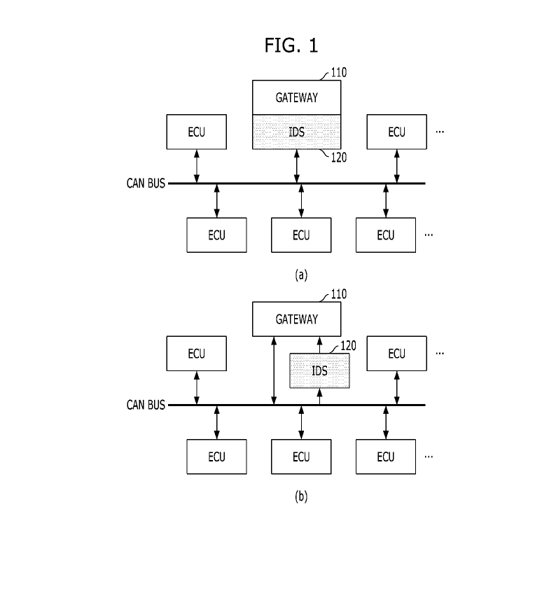

FIG. 1 shows exemplary installation locations of an IDS 120 in a vehicle according to embodiments of the present disclosure.

The IDS 120 may be installed in a gateway 110 of a controller area network (CAN) as illustrated in installation (a) of FIG. 1, or may be connected to a bus as an independent entity and communicate with the gateway 110 as illustrated in installation (b) of FIG. 1.

Irrespective of the installation location thereof, the IDS 120 according to the present disclosure may receive operation state information of the vehicle from the gateway 110 and ECUs, and monitor all messages in the CAN network.

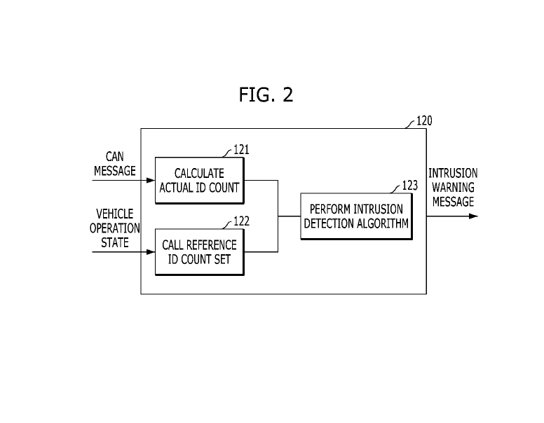

FIG. 2 is a block diagram showing an exemplary structure of the IDS 120 according to embodiments of the present disclosure.

As shown in FIG. 2, the IDS 120 according to the present disclosure may include a first module 121, a second module 122 and a third module 123. The functionality of each of the first module 121, the second module 122, and the third module 123 may be controlled by a control unit of the IDS 120. That is, a control unit, as defined hereinabove, of the IDS 120 may be responsible for implementing the first module 121, the second module 122, and the third module 123 of the IDS 120. Algorithms performed by each of the first module 121, the second module 122, and the third module 123 are described in detail below.

The first module 121 may receive all messages of the CAN network of the vehicle. The first module 121 extracts identifier (ID) values from the CAN messages received for a predetermined period of time, and calculates an actual ID count per ID based on the extracted IDs.

The second module 122 may receive operation state information of the vehicle from the gateway 110 and/or the ECUs. The second module 122 preliminarily stores reference ID count sets corresponding to normal vehicle operations and determines a reference ID count set corresponding to operation state information of the vehicle by calling the reference ID count set if the operation state information is input.

The third module 123 performs calculation based on an intrusion detection algorithm according to the current embodiment using the calculated and determined values of the first and second modules 121 and 122. If an intrusion is detected as a result of the calculation, the third module 123 may output a warning message.

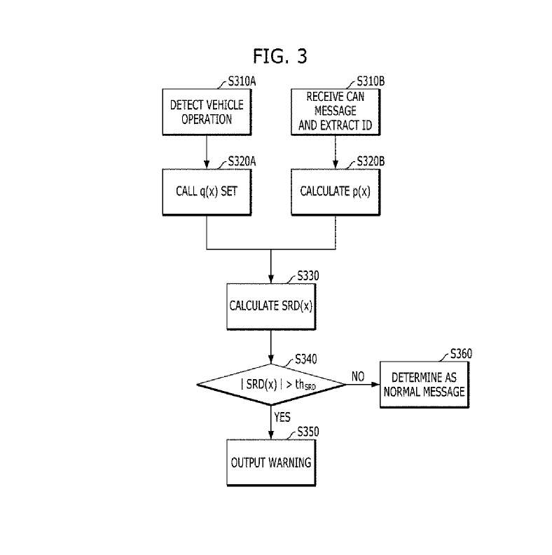

A detailed description is now given of the intrusion detection algorithm according to the present disclosure with reference to FIG. 3.

FIG. 3 is a flowchart of an intrusion detection algorithm performed by the IDS 120 according to embodiments of the present disclosure.

The IDS 120 may perform the algorithm illustrated in FIG. 3 in a preset checking cycle.

As the checking cycle starts, operation state information of the vehicle is input from the gateway 110 and the ECUs (S310A), and a q(x) set corresponding to the operation state information is called (320A). Here, x denotes an ID of a message, and q(x) denotes an ID x count in a predetermined cycle in normal operation.

If packets are input to the bus, ID (x) values of the packets are extracted to count each ID (S310B), and p(x) is calculated when the cycle ends (S320B). Here, p(x) may be defined as given by Equation 1.

$$p ( x ) = \frac{x count in 1 cycle}{packet count in 1 cycle} \qquad [ Equation 1 ]$$

Unlike Equation 1, the denominator may be omitted and p(x) may be simplified into a c count in one cycle.

Then, SRD_{p|q}(x) using p(x) and q(x) as input values may be calculated (S330). SRD_{p|q}(x) may be a function obtained by approximating a relative distance RD_{p|q}(x) which is an entropy-based function.

The relative distance RD_{p|q}(x) may be calculated as given by Equation 2.

$${RD}_{p \vert q} ( x ) = p ( x ) log \frac{p ( x )}{q ( x )} \qquad [ Equation 2 ]$$

Here, SRD_{p|q}(x) is a function obtained by linearly approximating the log part of RD_{p|q}(x), and enables efficient calculation.

Furthermore, according to embodiments of the present disclosure, SRD_{p|q}(x) may be calculated as given by Equation 3.

—SRD_{p|g}(x)=p(x)ƒₗ(a(x)) [Equation 3]

Here,

$$a ( x ) = \frac{p ( x )}{q ( x )}$$

may be satisfied. As described above, x denotes an ID of a message, q(x) denotes an x count in a predetermined cycle in normal operation, and p(x) denotes an ID x count calculated based on received messages.

The linear function ƒₗ(x) is calculated as given by Equation 4.

$${f}_{l} ( x ) = \{ \begin{matrix}4 x - 4 , & if 0 < x < 1 \\ x - 1 , & if 1 \leq x < 2 \\ \frac{1}{2} x , & if 2 \leq x < 4 \\ \frac{1}{4} x + 1 , & if 4 \leq x < 8 \\ \frac{1}{8} x + 2 , & if x \geq 8\end{matrix} \qquad [ Equation 4 ]$$

ƒₗ(x) receives x satisfying x>0, as input, and may be easily calculated on a bit basis by approximating the linear coefficient in the form of 2̂n.

After SRD_{p|q}(x) is calculated using one of the above-described methods, SRD_{p|q}(x) may be compared to a preset threshold value th_{SRD} (S340). th_{SRD} may be flexibly changed depending on the condition of the vehicle or the result of intrusion detection.

The IDS 120 ultimately determines whether an abnormal message is generated, based on the result of comparison in one checking cycle, determines an intrusion state and generates a warning if SRD_{p|q}(x) is greater than th_{SRD} (S350), and determines a normal state and terminates the cycle if SRD_{p|q}(x) is not greater than th_{SRD} (S360).

In FIG. 3, S310A and S320A may be performed by the second module 122 of FIG. 2, S310B and S320B may be performed by the first module 121, and the other steps may be performed by the third module 123.

A description is now given of a change in q(x) indicating an ID x count in normal operation, and a method for updating q(x).

As a new ECU is additionally installed in the CAN network or firmware is updated, if a new ID is generated or the cycle of a message having a specific ID is changed, the ID x count q(x) in normal operation is changed. In this case, updating of q(x) is required and the present disclosure proposes two methods to update q(x).

Initially, updating from the outside of the IDS 120 may be considered. Specifically, information about the changed q(x) set may be received from the outside and may be newly stored in and applied to the IDS 120. In this regard, a new q(x) value may be downloaded through a wireless network, or updating using a diagnosis network of a repair shop is also possible. However, when the wireless network is used, an update message needs to be authenticated.

Alternatively, updating through learning within the IDS 120 may be considered. Specifically, when p(x) values of messages received by the IDS 120 are determined as being normal, the p(x) set determined as being normal may be reflected in the q(x) set. In this case, an updated q′(x) value may be expressed as given by Equation 5.

$${q}^{′} ( x ) = \frac{Mp ( x ) + Nq ( x )}{M + N} \qquad [ Equation 5 ]$$

In Equation 5, M denotes a constant indicating a weight for updating p(x), and N denotes a large constant satisfying N>>M. The degree by which p(x) used for updating is reflected in q′(x) may be flexibly determined depending on relative sizes of M and N.

Meanwhile, the intrusion detection may be performed based on message context. Specifically, the algorithm according to the present disclosure may be modified and applied to intrusion detection based on message context as well as IDs. For example, SRD(x) operation may be performed by receiving message context as input. In this case, x denotes a message context value of a predetermined range. To detect a change in message context, conditional self information I(x|y) may be used instead of SRD(x). I(x|y) may be expressed as given by Equation 6.

$$I ( x \vert y ) = log \frac{1}{p ( x \vert y )} \qquad [ Equation 6 ]$$

In Equation 6, x denotes a message context value at a current time, and y denotes a message context value at a previous time. p(x|y) is a conditional probability of x for y, and the probability distribution p may be preliminarily stored in the IDS 120. Since I(x|y) is also based on log, I(x|y) may be linearly approximated similarly to SRD(x). If a linearly approximated function SI(x|y) is used instead of I(x|y), more efficient calculation is possible.

According to the above-described embodiments, a vehicle and ECUs may be safely protected from intrusion through a CAN network, and manipulation or remodeling thereof may be prevented. In addition, since detection may be performed without inputting additional data to a CAN bus, additional load of in-vehicle communication may be minimized. Furthermore, since checking is performed using only a part of CAN data, system delay in the vehicle may be reduced. In this case, since efficient calculation is performed by approximating entropy of CAN network data, the present disclosure is applicable to the ECUs in the vehicle.

According to embodiments of the present disclosure, the following effects are achieved.

Intrusion into an in-vehicle network, which potentially disturbs safe driving, may be detected and prevented. Furthermore, since efficient calculation is performed using a CAN message of the network, the techniques described herein may be applied within a vehicle.

It will be appreciated by persons skilled in the art that the effects that could be achieved through the present disclosure are not limited to what has been particularly described hereinabove and other advantages of the present disclosure will be more clearly understood from the detailed description.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A method for detecting intrusion into an in-vehicle network using an intrusion detection system (IDS) of a vehicle, the method comprising:
receiving messages of the in-vehicle network in a preset cycle;
calculating a current count value per message of the received messages;
receiving operation state information of the vehicle when the cycle starts;
determining a normal count value per message corresponding to the operation state information;
calculating a linearly approximated relative distance function per message using the current count value and the normal count value; and
determining whether an intrusion state occurs by comparing the calculated linearly approximated relative distance function per message to a preset threshold value.

2. The method according to claim 1, wherein the operation state information of the vehicle is inputted from at least one of a gateway and one or more electronic control units (ECUs).

3. The method according to claim 1, wherein the messages are controller area network (CAN) messages.

4. The method according to claim 1, wherein the IDS is located in a gateway of a CAN network.

5. The method according to claim 1, wherein the calculating of the current count value comprises:
extracting identifiers (IDs) of the messages; and
calculating an ID count per ID based on the extracted IDs.

6. The method according to claim 5, further comprising:
obtaining the current count value by dividing the ID count per ID in the cycle by a total packet count in the cycle.

7. The method according to claim 1, further comprising:
updating the normal count value by receiving a new normal count value from outside of the IDS.

8. The method according to claim 1, further comprising:
determining the normal count value by applying a predetermined weight to a current count value corresponding to a normal state.

9. The method according to claim 1, further comprising:
calculating the linearly approximated relative distance function by multiplying the current count value by a value obtained by performing a log operation on a value obtained by dividing the current count value by the normal count value.

10. The method according to claim 9, wherein the linearly approximated relative distance function is obtained by linearly approximating the log operation of the relative distance function.

11. An intrusion detection system (IDS) of a vehicle, the IDS comprising:
a first module receiving messages of an in-vehicle network in a preset cycle and calculating a current count value per message of the received messages;
a second module receiving operation state information of the vehicle when the cycle starts and determining a normal count value per message corresponding to the operation state information; and
a third module calculating a linearly approximated relative distance function per message using the current count value and the normal count value and determining whether an intrusion state occurs by comparing the calculated linearly approximated relative distance function per message to a preset threshold value.

12. The IDS according to claim 11, wherein the operation state information of the vehicle is inputted from at least one of a gateway and one or more electronic control units (ECUs).

13. The IDS according to claim 11, wherein the IDS is located in a gateway of a CAN network.

14. The IDS according to claim 11, wherein the first module extracts identifiers (IDs) of the messages and calculates an ID count per ID based on the extracted IDs.

15. The IDS according to claim 15, wherein the current count value is obtained by dividing the ID count per ID in the cycle by a total packet count in the cycle.

16. The IDS according to claim 11, wherein the normal count value is updated by receiving a new normal count value from outside of the IDS.

17. The IDS according to claim 11, wherein the normal count value is determined by applying a predetermined weight to a current count value corresponding to a normal state.

18. The IDS according to claim 11, wherein the linearly approximated relative distance function is calculated by multiplying the current count value by a value obtained by performing a log operation on a value obtained by dividing the current count value by the normal count value.

19. The IDS according to claim 19, wherein the linearly approximated relative distance function is obtained by linearly approximating the log operation of the relative distance function.

20. A non-transitory computer readable medium containing program instructions for detecting intrusion into an in-vehicle using an intrusion detection system (IDS) of a vehicle, the computer readable medium comprising:
program instructions that receive messages of the in-vehicle network in a preset cycle;
program instructions that calculate a current count value per message of the received messages;
program instructions that receive operation state information of the vehicle when the cycle starts;
program instructions that determine a normal count value per message corresponding to the operation state information;
program instructions that calculate a linearly approximated relative distance function per message using the current count value and the normal count value; and
program instructions that determine whether an intrusion state occurs by comparing the calculated linearly approximated relative distance function per message to a preset threshold value.
